(19) United States
(12) Patent Application Publication
(10) Pub. No.: US 2025/0314126 A1
(43) Pub. Date: Oct. 9, 2025

(54) LOUVER APPARATUS WITH INDEPENDENT TOP AND BOTTOM, AND DRAWER-TYPE BUILDING ENVELOPE STRUCTURE USING SAME

(71) Applicant: SAMOO ARCHITECTS&ENGINEERS CO.,LTD, Seoul (KR)

(72) Inventors: Chang Kyu SOHN, Seoul (KR); Dong Hoon KIM, Hanam-si, Gyeonggi-do (KR); Ju Byung LEE, Yongin-si, Gyeonggi-do (KR); Shin Jae LEE, Seoul (KR); Ha Won YOON, Seoul (KR); Dae Soon KIM, Seoul (KR); Jun Young YANG, Seoul (KR); GUEN IL HUH, Seoul (KR); Jun Yub KIM, Seoul (KR); Sang Eun HAN, Seoul (KR)

(73) Assignee: SAMOO ARCHITECTS&ENGINEERS CO.,LTD, Seoul (KR)

(21) Appl. No.: 18/866,440

(22) PCT Filed: Jan. 30, 2024
(86) PCT No.: PCT/KR2024/001417

§ 371 Date: Nov. 15, 2024

(30) Foreign Application Priority Data
Apr. 17, 2023 (KR) 10-2023-0050291
May 31, 2023 (KR) 10-2023-0069952

(51) Int. Cl. E06B 9/36; E04B 2/90

(52) U.S. Cl. CPC E06B 9/368; E04B 2/90; E06B 9/361

(57) ABSTRACT

The present invention relates to a louver apparatus with independent top and bottom, the louver allowing being opened and closed from the top or bottom independently. The louver apparatus comprises: a rail means comprising an upper rail and a lower rail; a turning means installed in accommodating spaces of the upper and lower rails so as to be operated independently; and a louver means positioned between the upper rail and lower rail to rotate the slats according to the operation of the turning means.

### TECHNICAL FIELD

The present invention relates to a vertical louver installed on a building envelope structure and, more specifically, to a technology for a louver apparatus with independent top and bottom, which allows louvers to be opened and closed independently at the top and the bottom.

### BACKGROUND ART

Louvers are installed on windows or openings of a building to block external views into the interior or for purposes of lighting and ventilation.

The louver generally includes a vertical or horizontal band-type panel installed on an upper frame of a window, and users can manually or electrically adjust the angle to control the open area, thereby seeking a comfortable indoor environment.

For instance, Korean Patent No. 10-0863323 discloses a louver apparatus that facilitates angle adjustment of louvers in an electronic manner.

The louver apparatus includes a rail mounted on an upper portion of a window frame, a driving unit installed on the rail to move a slider, the slider inserted inside the rail to be movable, a rotating member installed on the slider to rotate a shading louver, and a controller for controlling the driving unit.

The louver apparatus transmits the external environmental conditions detected by an external sensor to a control unit of the controller. The control unit compares the detected conditions with preset condition values and controls the driving unit based on the compared result to rotate the louver at an angle set by a user.

Meanwhile, the direction of sunlight is changed according to seasons and time of day and varies depending on the installation location and direction of the louver.

However, the conventional louver apparatus disclosed in Korean Patent No. 10-0863323 cannot cope with various directions of sunlight since all of the louvers rotate at the same angle, thus having a limitation in meeting users' needs for the indoor environment.

### DISCLOSURE

### Technical Problem

Accordingly, the present invention has been made in view of the above-mentioned problems occurring in the related art, and it is an objective of the present invention to provide a louver apparatus, which allows free setting of opening position and area of louvers, thereby continuously maintaining optimized indoor environments in response to various directions of sunlight.

It is another objective of the present invention to provide a drawer-type envelope structure of a building, which can replace the louver apparatus, thereby improving the ease in maintenance, and expressing various dynamic appearances of the building.

It is a further objective of the present invention to provide a control system which operates the louver apparatus in association with mechanical facilities, such as heating and lighting for indoor environment, thereby minimizing the use of electrical energy.

### Technical Solution

To accomplish the above-mentioned objects, according to the present invention, there is provided a louver apparatus including: a rail means having an upper rail and a lower rail; a turning means installed in accommodating spaces of the upper and lower rails so as to be operated independently; and a louver means positioned between the upper rail and the lower rail to rotate the slats according to the operation of the turning means.

In the most preferred embodiment, the turning means includes a plurality of gearboxes, a drive motor, and a drive shaft which rotates by the drive motor, and wherein the gearbox includes a wheel gear installed on the drive shaft, a worm gear meshing with the wheel gear, and a worm shaft fixing the worm gear while rotating the slat block.

In the most preferred embodiment, the louver means includes slat blocks connected to both ends of the slats and connectors connecting the slat block and the turning means, wherein the slat block includes an upper slat block that fixes the top of the slat and a lower slat block that fixes the bottom of the slat, and at least one of the upper slat block and the lower slat block includes an expansion means that allows for changes in the length between the upper and lower slat blocks.

In this instance, an impact-absorbing material can be installed at the side end of the slat block.

The connector can be installed in the center of the slat block, and the expansion means can be installed on each side of the connector.

Furthermore, the slat block is in a tubular shape and has a fixed space therein. The expansion means includes a moving block embedded in the fixed space and moving vertically, a tension-adjusting bolt passing through one end side of the slat block and screw-coupled to one end of the moving block, and a spring installed between a head of the tension-adjusting bolt and the slat block.

Additionally, in the most preferred embodiment, an envelope structure of a building includes: a support frame installed on a structure of the building; a guide frame installed on the support frame and protruding outside the building; and an exterior enclosure installed in the guide frame in a drawer-like manner and containing the louver device.

In the most preferred embodiment, the exterior enclosure includes: an exterior frame having a glass panel; a fixed frame located behind the exterior frame; and a connection frame connecting the exterior frame and the fixed frame and fixing the rail means of the louver device.

In this instance, an exterior strip inclined downward outwardly is installed in front of the guide frame, an air circulation opening is formed between the exterior strip and the exterior enclosure, an airflow meter is installed inside the air circulation opening, a solarimeter is installed on the front of the exterior frame, and a surface temperature sensor is installed on the fixed frame.

In the most preferred embodiment, a control system controlling the louver apparatus in the envelope structure in which the louver apparatus is installed in the exterior enclosure continuously repeats a cycle including: a) a monitoring step for the normal operation of the control system and the louver apparatus (R); b) a step of transmitting status information of the louver apparatus (R) to a system integration system and receiving building and indoor environmental information from the system integration system; c) a louver apparatus operating step of verifying the received building and indoor environmental information and the content of control commands entered into the louver apparatus (R) and operating the louver apparatus (R) by any one of an emergency mode, a schedule mode, a manual mode, and a user mode; and d) a step of updating the operation information of the louver apparatus.

### Advantageous Effect

The present invention provides the following effects by independently rotating the top and bottom ends of the slats, unlike the conventional louver apparatuses.

Firstly, the present invention allows for very fine adjustments of the window area ratio, which is directly related to solar energy blocking and energy efficiency.

Secondly, the present invention can tightly fix the top and bottom of the slats to form a space that traps cold air between the glass panel and the louver apparatus during winter, thereby reducing indoor heating energy loss, and reduce indoor cooling energy loss by blocking solar energy in summer.

Thirdly, the present invention can prevent glare for occupants and allows for a larger open area, thereby creating a bright and comfortable indoor environment.

Fourthly, the present invention can minimize the use of electrical energy for indoor lighting and secure the necessary indoor illumination levels.

Fifthly, the present invention can change the appearance in various shapes to provide dynamic appearances, thereby realizing a building with high symbolic value.

In addition, the louver apparatus is installed in the exterior enclosure in the drawer-like manner, thereby facilitating replacement of the louver apparatus, allowing for efficient management by the control system, and enabling economical maintenance by coping with emergencies such as fire and strong winds.

### DESCRIPTION OF DRAWINGS

FIG. 1 is a perspective view of a louver apparatus according to an embodiment of the present invention.

FIG. 2 is a front view of the louver apparatus.

FIG. 3 is a plan view showing the inside of a rail means of the louver apparatus.

FIG. 4 is a partially exploded perspective view of the louver apparatus.

FIG. 5 is a cross-sectional and detailed view taken along line A-A of FIG. 2.

FIG. 6 is a cross-sectional view showing ends of slats fixed to a slat block of the louver apparatus.

FIG. 7 is a cross-sectional view taken along line B-B of FIG. 2.

FIG. 8 is a front view illustrating an example of the operation of the louver apparatus.

FIG. 9 is a front view illustrating another example of the operation of the louver apparatus.

FIG. 10 is a cross-sectional view showing an expansion means installed in the slat block.

FIG. 11 is a cross-sectional view showing a shock-absorbing material installed in the slat block.

FIG. 12 is a cross-sectional view showing the louver apparatus installed in an exterior enclosure of an envelope structure.

FIG. 13 is an explanatory diagram of a process of forming the envelope structure of a building according to the present invention.

FIG. 14 is an explanatory diagram of a process of replacing the louver apparatus in the envelope structure.

FIG. 15 is a flowchart of the operation of a control system of the present invention.

FIG. 16 is an explanatory diagram of a schedule mode of the control system.

### BEST MODE

A louver apparatus according to the most preferred embodiment includes: a rail means having an upper rail and a lower rail; a turning means installed in accommodating spaces of the upper and lower rails so as to be operated independently; and a louver means positioned between the upper rail and the lower rail to rotate the slats according to the operation of the turning means.

### MODE FOR INVENTION

Hereinafter, the most preferred embodiment of the present invention will be described in detail with reference to the accompanying drawings. However, in describing the present invention, detailed description of relevant known configurations will be omitted if it is determined that such description may make the technical idea of the present invention unclear or obscure.

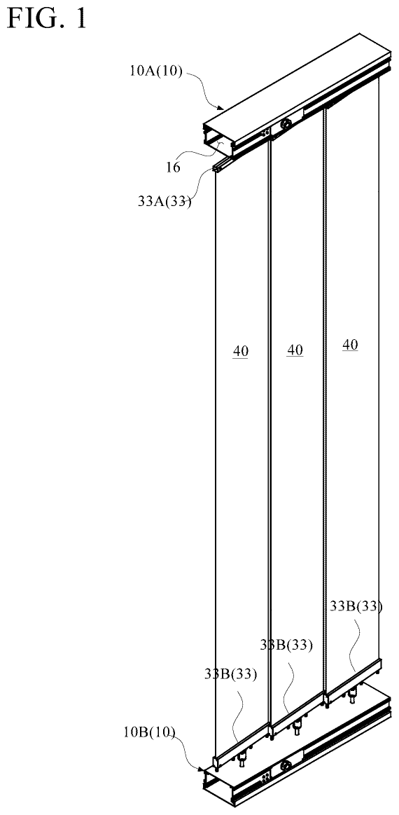

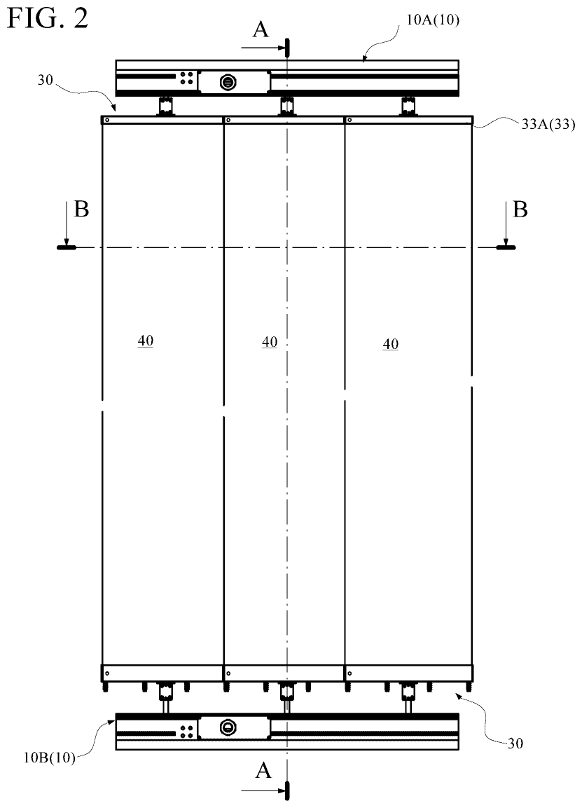

FIG. 1 shows an overall appearance of a louver apparatus (R) according to an embodiment of the present invention, and FIG. 2 illustrates the state of the louver apparatus (R) viewed from the front.

The louver apparatus (R) of the present invention includes a rail means 10, a turning means 20, and a louver means 30.

The rail means 10 forms the upper and lower peripheral appearance of the louver apparatus (R), which is installed on a fixing member of a building or an exterior enclosure 130, and includes a U-shaped cross-section body 11, which has an accommodating space 16 allowing the turning means 20 to be accommodated, and a detachable rail cover 15 which covers an opening of the body 11.

On a side panel 11a of the body 11, fastening holes 12 and a working plate 13 for a bracket for installation of a drive motor 21 are formed. Ona bottom plate 11b or an upper plate 11c, shaft holes 14 for the passage of a worm shaft 28 are formed. The working plate 13 is closed by a motor cover 17, and a connector 18 for the wiring for the drive motor 21 is installed on the motor cover 17.

Unlike typical louver apparatuses (R), the rail means 10 includes an upper rail 10A located at the top of the louver means 30 and a lower rail 10B located at the bottom of the louver means 30. Additionally, turning means 20 are respectively installed in the upper rail 10A and the lower rail 10B.

The turning means 20 allow a plurality of slats 40, which function as a screen through the louver means 30, to create various opening shapes or appearances within a range set by the rail means 10 while rotating.

As illustrated in FIGS. 1 and 2, the louver means 30 includes slat blocks 33 connected to both ends of the slats 40 and connectors 32 connecting the slat blocks 33 to the turning means 20.

As described above, the louver means 30 operates so that the slats 40 rotate according to the operation of turning means 20, thereby achieving the appearance shapes demanded by a user.

Furthermore, the louver apparatus (R) will be described in detail as follows.

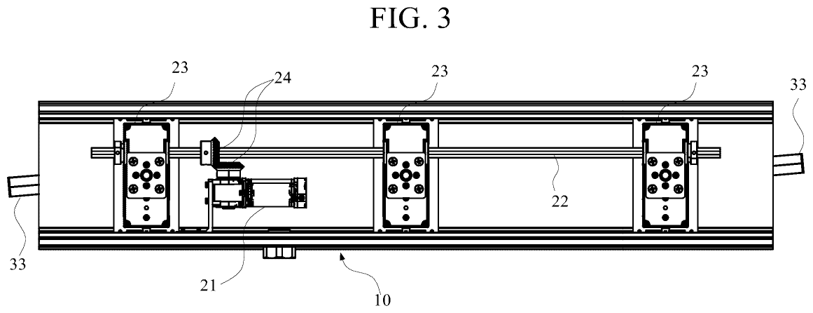

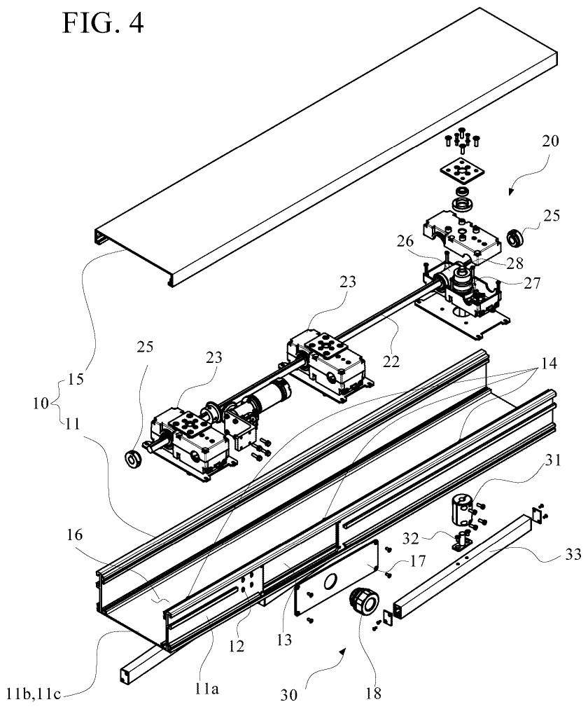

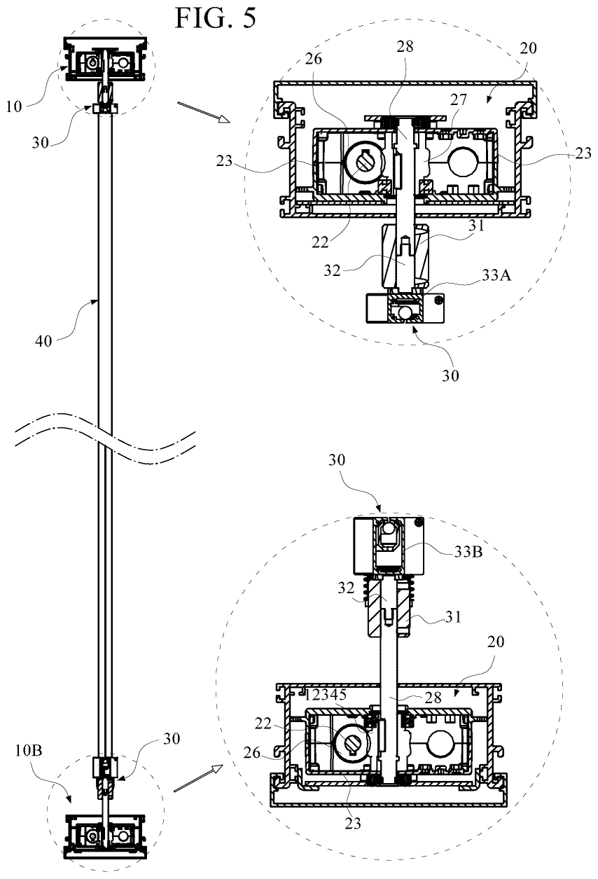

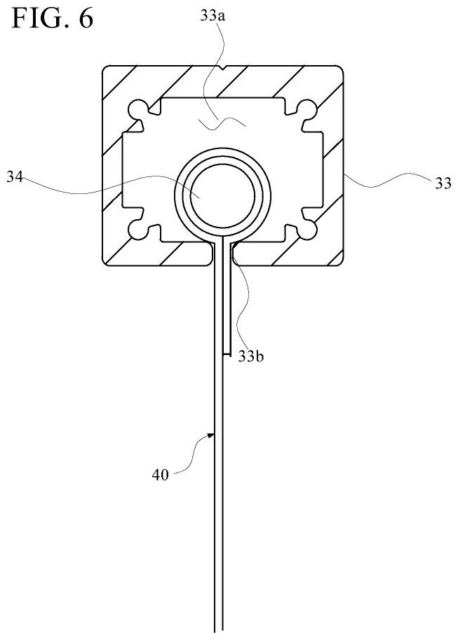

FIG. 3 illustrates a state in which the turning means 20 is housed in the rail means 10, and FIG. 4 is a partially exploded view of the louver apparatus (R), FIG. 5 is a cross-sectional view taken along line A-A of FIG. 2, showing the connection between turning means 20 and louver means 30, and FIG. 6 illustrates a state in which the ends of the slats 40 are fixed to the slat block 33.

As illustrated in FIG. 4, the turning means 20 includes a plurality of gearboxes 23, a drive motor 21, and a drive shaft 22.

The gearboxes 23 house mechanisms that enable the slats 40 to rotate as the drive shaft 22 turns. For example, as illustrated in FIG. 5, a wheel gear 26, a worm gear 27 meshing with the wheel gear 26, and a worm shaft 28 are housed in each gearbox 23.

The wheel gear 26 is fixedly mounted on the drive shaft 22 to rotate with the drive shaft 22. Additionally, the worm gear 27 is fixedly mounted on the worm shaft 28. Moreover, the worm shaft 28 is integrated with a connector 32 of the louver means 30 through a coupling 31.

The drive motor 21 is fixedly installed on the rail means 10 via a bracket, and rotates the drive shaft 22 via a bevel gear 24. Shaft stoppers 25 are installed on both ends of the drive shaft 22 to prevent lateral movement of the drive shaft 22.

When the wheel gear 26 rotates along the drive shaft 22 rotating by the operation of drive motor 21, the worm gear 27 rotates to rotate the worm shaft 28, such that the connector 32 connected to the slat block 33 is rotated.

Furthermore, the slat block 33 has a tubular shape and includes a fixed space 33a formed therein. A slit-shaped insertion opening 33b is formed on one side of the fixed space 33a. As illustrated in FIG. 6, one end of the slat 40 is inserted into the insertion opening 33b, and then, is fixed to a fixing rod 34.

As the slat block 33 rotates, the slat 40 also rotates accordingly.

The slat block 33 of the louver means 30 includes an upper slat block 33A that fixes the top of the slat 40 and a lower slat block 33B that fixes the bottom of the slat 40. Therefore, the upper slat block 33A and the lower slat block 33B are installed on one slat 40, and the turning means 20 are respectively installed on the upper and lower slat blocks 33A and 33B.

One end of the connector 32 of the louver means 30 is fixed to the slat block 33 and the other end is coupled and fixed to the worm shaft 28 to be integrated.

The turning means 20 installed on the upper rail 10A and the lower rail 10B are operated independently.

Accordingly, the plurality of slats 40 form various shapes of openings or appearances as described. For example, the opening area of the upper portion and the opening area of the lower portion can be formed differently depending on the rotation angle of the slat block 33 or the slat 40.

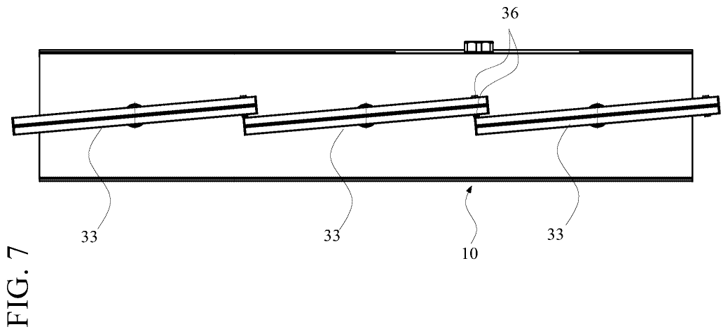

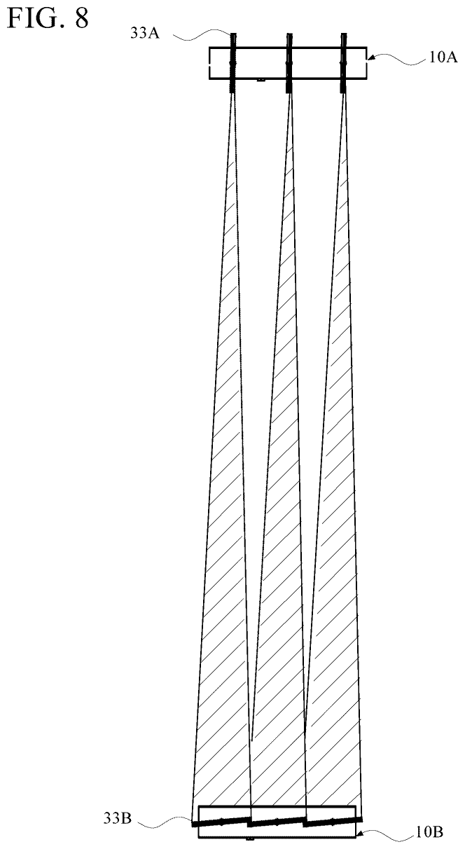

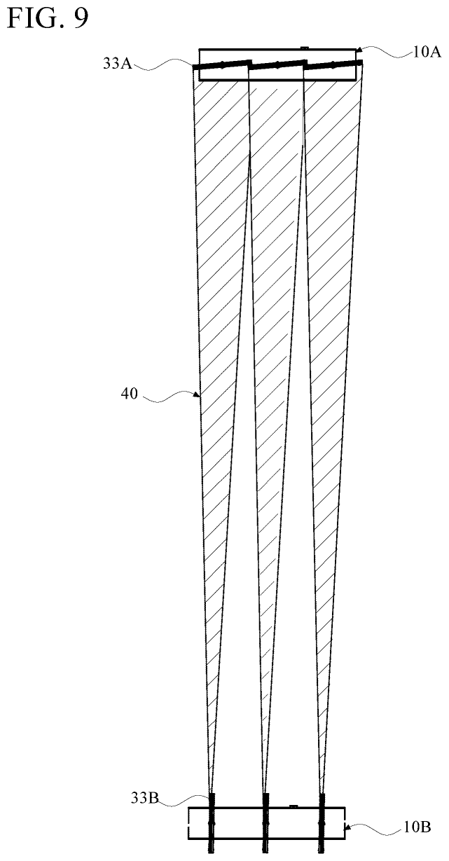

FIGS. 7 to 9 illustrate the above, wherein FIG. 7 illustrates a cross-section along line B-B of FIG. 2, FIG. 8 illustrates a state with only the upper portion open, and FIG. 9 illustrates a state with only the lower portion open.

Meanwhile, as illustrated in FIGS. 8 and 9, when the rotation angles of the upper slat block 33A and the lower slat block 33B of the louver apparatus (R) are varied, the length between the ends of the upper slat block 33A and the lower slat block 33B is changed.

To cope with the length changes, the slats 40 may be configured to have elastic force, but in another embodiment of the present invention, an expansion means allowing for length changes between the upper slat block 33A and the lower slat block 33B may be provided on any one of the upper slat block 33A and the lower slat block 33B.

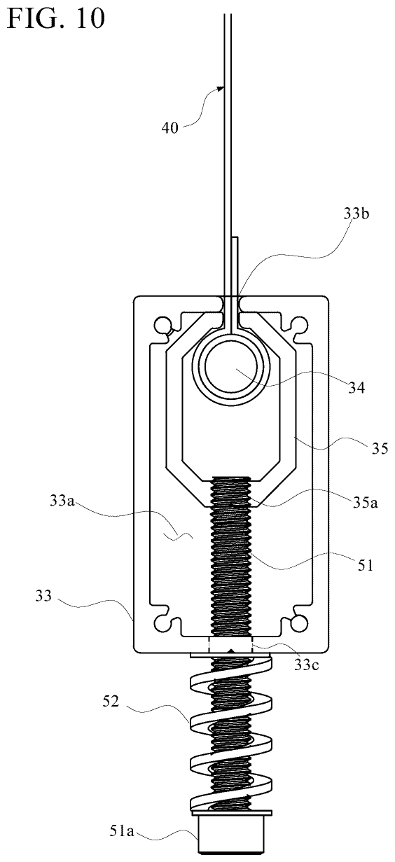

FIG. 10 illustrates the expansion means according to an embodiment of the present invention.

The expansion means includes a moving block 35 housed in the fixed space 33a of the slat block 33, a tension-adjusting bolt 51 connected to the moving block 35, and a spring 52 providing elastic force to the tension-adjusting bolt 51.

That is, In the location of the slat block 33 where the expansion means is provided, the fixing rod 34 to which the end of the slat 40 is fixed is not directly embedded in the fixed space 33a but is indirectly housed inside the fixed space 33a by being located within the moving block 35.

In this instance, the moving block 35 is configured to move vertically within the fixed space 33a. Additionally, the tension-adjusting bolt 51 passes through a through-hole 33c formed on one end side of the slat block 33, and then, is screw-coupled to a spiral hole 35c formed on one end side of the moving block 35, and the spring 52 is installed between the slat block 33 and a head 51a of the tension-adjusting bolt 51.

Thus, according to the degree of fastening of the tension-adjusting bolt 51 to the moving block 35, the restoring force by the spring 52 increases and decreases, altering the flexibility of the expansion in response to changes in the length between the upper slat block 33A and the lower slat block 33B. Therefore, when the user adjusts the tension-adjusting bolt 51 considering the material characteristics of the slat 40, the slat 40 can always maintain the taut state without any damage and the upper slat block 33A and lower slat block 33B rotate at different angles, thereby realizing the intended twisted shape stably.

Meanwhile, when the rotation angles of the upper slat block 33A and the lower slat block 33B of the louver apparatus (R) are varied, the changes in length between the upper slat block 33A and the lower slat block 33B occur more significantly towards the outer sides from the central line of rotation. Thus, the connector 32 is installed in the center of the slat block 33, which is the central line of rotation, and the expansion means should be respectively installed on right and left sides around the slat block. However, it is not necessary to install the expansion means to be symmetrically to the connector 32.

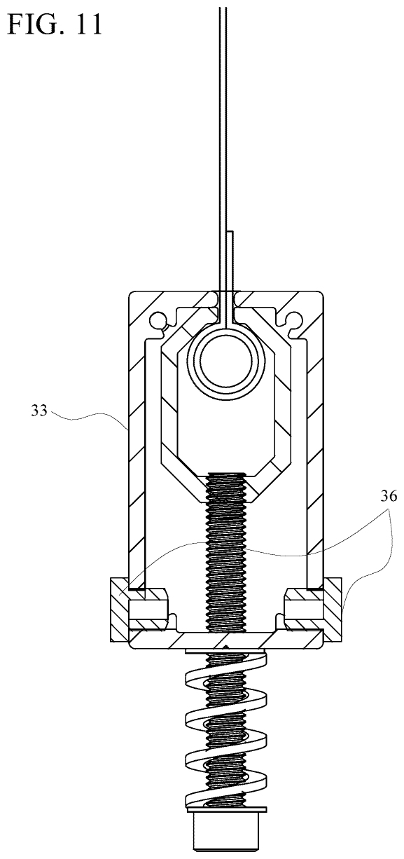

FIG. 11 illustrates the state in which the shock-absorbing material 36 is installed on the side end of the slat block 33.

When the louver apparatus (R) is closed, the side ends of adjacent slats 40 should overlap completely to fully block the inside from the outside. Therefore, during the rotation of the slat blocks 33, the slat blocks 33 may collide with each other. In this instance, the shock-absorbing material 36 absorbs the collision impact between the adjacent slat blocks 33, preventing damage or deformation of the slat blocks 33.

The louver apparatus (R) of the present invention, as described, can applied to a drawer-type envelope structure 100 of a building, allowing for efficient management and the creation of various external appearances of the building.

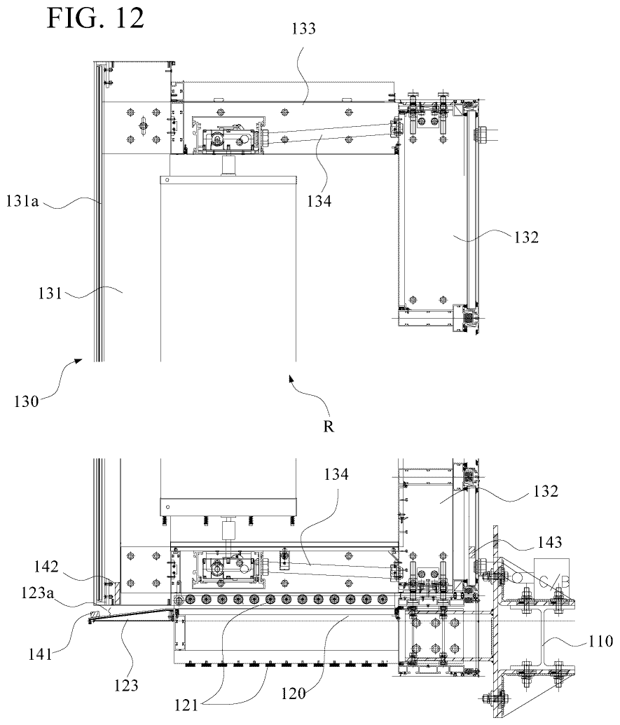

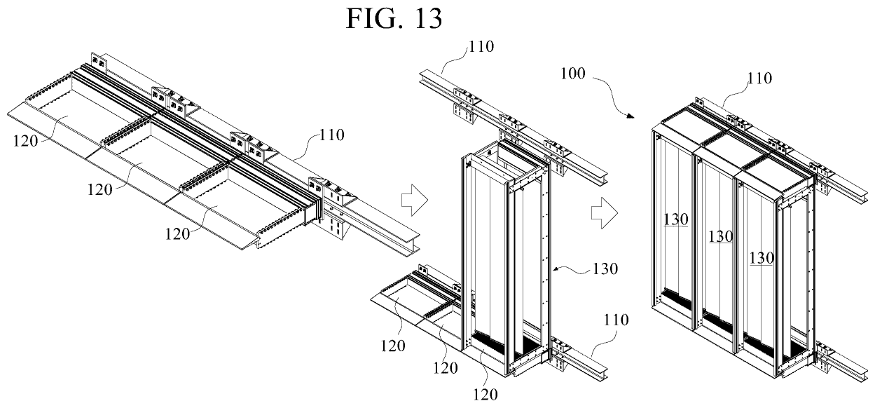

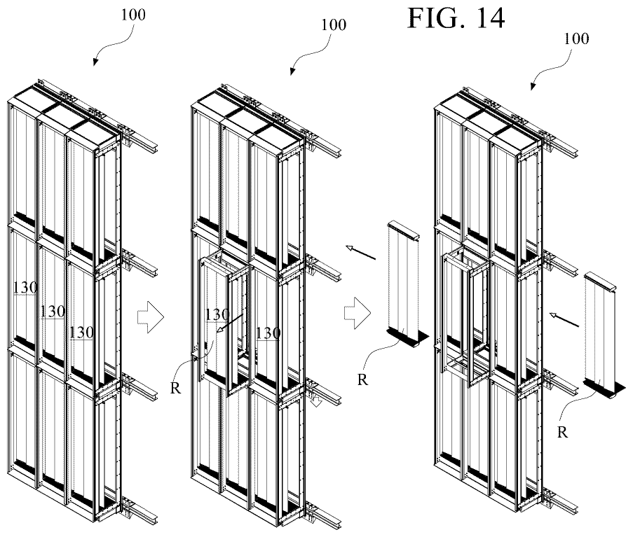

FIGS. 12 to 14 illustrate the drawer-type envelope structure 100 of the building, wherein FIG. 12 illustrates a state in which the louver apparatus (R) is installed in the exterior enclosure 130, FIG. 13 illustrates the process of forming the envelope structure 100, and FIG. 14 illustrates the process of replacing the louver apparatus (R) within the envelope structure 100.

The envelope structure 100 includes a support frame 110 installed on a structure of a building, a guide frame 120 installed on the support frame 110 and protruding outward from the building, and an exterior enclosure 130 installed to be drawable from the guide frame 120.

The guide frame 120 supports the exterior enclosure 130 from below and allows any exterior enclosure 130 to be extracted and inserted in a drawer manner from the adjacent exterior enclosure 130, and further includes guide rollers 121 installed to facilitate the extraction and insertion.

An exterior strip 123 can be installed in front of the guide frame 120.

The exterior strip 123 finishes a wide space between the exterior strip 123 located at the upper portion and the exterior strip 123 located at the lower portion to improve the appearance. An air circulation opening 123a which communicates with the interior of the exterior enclosure 130 is formed between the exterior enclosures 130. In this instance, a flow meter 141 can be installed inside the air circulation opening 123a to enable efficient use of the louver apparatus (R).

The exterior enclosures 130 form the exterior of the building, and as described above, is installed on the guide frame 120 to be extracted in the drawer-like manner so that the louver apparatus (R) embedded in the exterior enclosure 130 can be easily replaced.

Of course, various devices with infrastructure functions for environmental control of the architectural space, such as air conditioning and telecommunications, can also be housed in the exterior enclosure 130, but, in the present invention, the louver apparatus (R) of the electronic structure is embedded in the exterior enclosure 130 and members for supporting the louver apparatus are installed. For instance, as illustrated in FIG. 12, a pyranometer 142 can be installed on the front of the exterior frame 131, and a surface temperature sensor 143 can be installed on the fixed frame 132. Additionally, a duct 134 for installing wires to apply power to the louver apparatus (R) can be further installed inside the exterior enclosure 130.

The exterior enclosure 130 is located outside the building envelope structure 100, and includes an exterior frame 131 where a glass panel 131a is installed, a fixed frame 132 located behind the exterior frame 131 where access windows, smoke vents, fixed insulation glass, etc., are installed, and a connection frame 133 which connects the exterior frame 131 and the fixed frame 132 while fixing the rail means 10 of the louver apparatus (R).

As described above, the envelope structure 100 of the present invention, which includes the guide frame 120 and the exterior enclosure 130, can be formed, as illustrated in FIG. 13, through the steps of: fixing and installing the guide frame 120 to the support frame 110, lifting the exterior enclosure 130 to mount on the guide frame 120, and fixing the exterior enclosure 130 to another exterior enclosure 130 adjacent to the guide frame 120.

Furthermore, the replacement of the louver apparatus (R) can be easily performed by releasing the portion where the exterior enclosure 130 which houses the louver apparatus (R) to be replaced is joined to the guide frame 120 and the adjacent exterior enclosure 130, and sliding the target exterior enclosure 130 outwards as illustrated in FIG. 14.

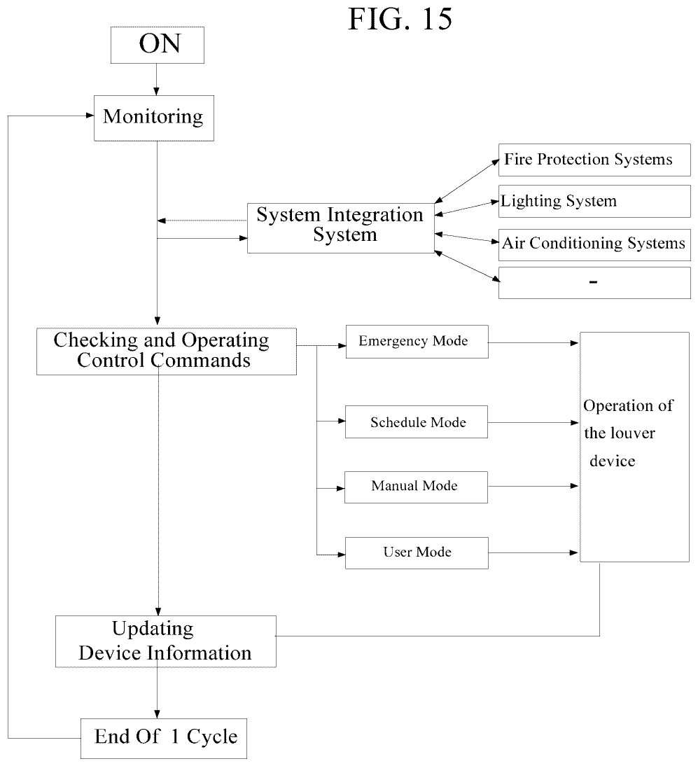

FIG. 15 illustrates the operation sequence of a control system of the present invention.

The louver apparatus (R) installed in the envelope structure 100 can be efficiently managed by the control system and maintain a comfortable indoor environment for occupants.

As illustrated in FIG. 15, the control system sequentially performs the following steps of: a) monitoring the normal operation of the control system and the louver apparatus (R); b) exchanging information with a system integration system; c) checking and operating control commands; and d) updating device information. The steps proceed in a very short cycle and the cycle is continuously repeated. The operation sequence of the control system will be described in detail as follows.

a) Monitoring the normal operation of the control system and the louver apparatus (R);

The initial operation of the louver apparatus (R) begins with the slats 40 aligned.

When an operator who controls all louver apparatuses (R) in the building turns on the control system, the control system monitors the louver apparatus (R) and the control system itself to check whether the louver apparatus (R) operates correctly according to the input commands and whether the cycle of the control system is performed normally, and if everything functions properly, progress to the next step of exchanging information through transmission and reception with the system integration system.

However, if abnormality in the louver apparatus (R) or the control system is detected, the system integration system displays the detected abnormality on a display device of a control room, enabling the operator to take necessary actions.

b) exchanging information with system integration system;

The system integration system manages the operational status information of various facilities within the building, such as air conditioning systems, lighting systems, and fire protection systems, and so on, and data from various sensors installed in the building, such as flow meters, lux meters, pyranometers 142, and surface temperature sensors 143, and so on to optimize the operation of each facility.

Thus, in this step, receiving building and indoor environmental information related to the operation of the louver apparatus (R) from the system integration system is performed, and then in the next step, the operation or the operation mode of the louver apparatus (R) and the operation direction of the louver apparatus (R) based on the received control commands can be determined.

In addition, in this step, the operational status of the louver apparatus (R) is transmitted to the system integration system, allowing the air conditioning systems or the lighting systems to consider the operational status, optimizing the operational status of each facility within the building.

c) checking and operating control commands;

In this step, a specific operation mode of the louver apparatus (R) is determined by verifying the received building and indoor environmental information and the content of the control commands input during the operation of the louver apparatus (R).

The operation modes include an emergency mode, a schedule mode, a manual mode, and a user mode. The operations modes will be described as follows.

The emergency mode involves operating the louver apparatus (R) in an appropriate state when environmental information about events such as fires or high winds is acquired.

For example, the operation of the louver apparatus (R) is affected by external environment conditions, such as fires or high winds, as well as situations directly related to the functions of the louver apparatus (R), such as solar radiation quantity, sun elevation, and indoor lux level. For instance, in the event of a fire, it is necessary to minimize the upward movement of flames or toxic gases by inducing them to the outside of the building.

Therefore, it is preferable to align the slats 40 at a certain angle or move the slats 40 to one side at least in locations where smoke vents or firefighter access points are located, to communicate with the outside.

In another example, when high wind occurs during the operation of the louver apparatus (R), the slats 40 may be damaged by wind pressure. So, it is necessary to align the slats 40 to minimize the impact of wind pressure on the slats 40.

The operation of the louver apparatus (R) is achieved in the emergency mode.

The schedule mode refers to a state set so that the operation of the louver apparatus (R) is based on at least one of the conditions of time, indoor lux level, sun elevation, or indoor energy use.

In the time-based schedule mode, the angle of slats 40 could be changed in the morning and afternoon, or the louver apparatus (R) could be opened only for a set period and closed at other times, thus changing the operation state of the louver apparatus (R) over time.

In the lux level-based schedule mode, the opening extent of the louver apparatus (R) is adjusted according to the indoor lux level detected in real-time by lux meters installed inside the building, and the optimal indoor lux level can be achieved in coordination with the indoor lighting system.

For instance, if the indoor lux level does not reach a set value, the louver apparatus (R) is opened to increase the indoor lux level through daylighting, and if the indoor lux level still does not reach the set value, the indoor lighting system is activated to ensure the indoor lux level reaches the set value.

In summer, when the indoor lux level is corrected by daylighting, excessive solar radiation can increase the cooling load inside. In such cases, considering the solar information, surface temperature information, and the heating and cooling information from the air conditioning system obtained from the system integration system, it is possible to secure the set lux level while adjusting the operation of the lighting facilities or heating and cooling facilities to minimize indoor energy use.

The schedule mode based on sun elevation aims to prevent dazzling for occupants by sunlight. The control system associates the building information, such as latitude, longitude, altitude, and orientation acquired using GPS with changes in sun elevation for the day to causes changes in angle or shape of the slats 40 of the louver apparatus (R).

The schedule mode based on energy use conditions functions to minimize building energy use using the louver apparatus (R). That is, the schedule mode based on energy use conditions aims to optimize energy consumption considering interior and exterior environments of the building, such as external temperature, solar radiation, occupancy density, and indoor lux level.

For example, when the louver apparatus (R) is opened during sunny daylight hours in winter, the influx of solar energy into the building is increased, reducing indoor heating energy loss. Meanwhile, when the louver apparatus (R) is closed during cloudy days or at night, a space that stagnates airflow between a glass panel 131a of the exterior enclosure 130 and the louver apparatus (R) is formed, reducing indoor heating energy loss to the cold outside air.

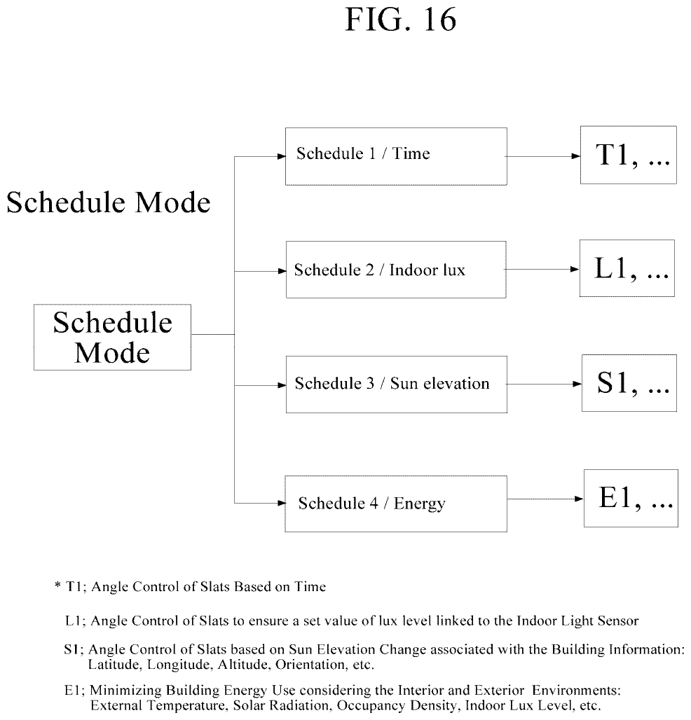

FIG. 16 illustrates the contents of the schedule modes, wherein each condition can be set singly or in combination.

A manual mode refers that the louver apparatus (R) is operated by an administrator's control due to direct intervention of the administrator to the control system.

For example, the administrator can arbitrarily change the angle of the slats 40 for all or part of the louver apparatus (R), or perform event control of the louver apparatus (R) for changing the appearance of the building.

Here, the event control means to operate the louver apparatus (R) to attract external attention by giving dynamic aesthetics to the appearance of the building through various shape and color changes of the slats 40.

For example, varying the front and back colors of the slats 40 and changes in rotation speed and direction of the upper slat block 33A and the lower slat block 33B can provide an effect similar to a card section.

Commands for the operation of the louver apparatus (R) can be executed by the administrator in the control room or by an authorized user in a specific room.

A user mode means that the authorized user can control some operations of the louver apparatus (R) as described.

That is, in the user mode, the user can control the angle of the slats 40 of the louver apparatus (R) located in the specific room by setting the time. For example, the user can provide control commands to the control system so that the louver apparatus (R) opens only the upper portion in the morning as illustrated in FIG. 8 and opens only the lower portion in the afternoon as illustrated in FIG. 9. In this case, the louver apparatuses (R) located in other areas of the building excepting the specific room operate according to the general schedule mode previously set or the mode set by the administrator.

d) Updating device information;

One cycle for the operation status of the louver apparatus (R) by each mode is ended through the step of updating device information. The updated operation status of the louver apparatus (R) will serve as the operating standard for the louver apparatus (R) until a set time or a new control command is input.

As described above, while the present invention has been described in detail with reference to specific embodiments, the examples are only to facilitate understanding of the present invention, and it is evident to those skilled in the art that various modifications can be made within the scope of the technical concept of the present invention without departing from the scope defined in the claims. Therefore, such modifications are considered to fall within the scope of the present invention.

### INDUSTRIAL APPLICABILITY

The present invention allows the upper and lower ends of the slats of the louver apparatus to rotate independently to finely adjust the window area ratio related to the solar energy at the upper and lower portions of the window, thereby reducing energy loss inside the building and allowing for a variety of changes to the appearance of the building. Therefore, the present invention has industrial applicability.

1. A louver apparatus with independent top and bottom comprising: a rail means (10), a turning means (20) installed in an accommodating space (16) provided in the rail means (10), and a louver means (30) that causes slats (40) to rotate according to the operation of the turning means (20), wherein the rail means (10) includes an upper rail (10A) located at an upper portion of the louver means (30) and a lower rail (10B) located at a lower portion of the louver means (30), and the turning means (20) installed on each of the upper rail (10A) and the lower rail (10B) are configured to operate independently, allowing an upper opening area and an lower opening area to be formed differently by the rotation angle of the slats (40),
wherein the louver means (30) includes slat blocks (33) connected to both ends of the slats (40) and connectors (32) connecting the slat block (33) and the turning means (20),
wherein the slat block (33) includes an upper slat block (33A) that fixes the top of the slat (40) and a lower slat block (33B) that fixes the bottom of the slat (40), and at least one of the upper slat block (33A) and the lower slat block (33B) includes an expansion means that allows for changes in the length between the upper and lower slat blocks, and
wherein the expansion means includes a moving block (35) embedded in the fixed space (33a) and moving vertically, a tension-adjusting bolt (51) passing through one end side of the slat block (33) and screw-coupled to one end of the moving block (35), and a spring (52) installed between a head of the tension-adjusting bolt (51) and the slat block (33).

2. The louver apparatus according to claim 1, wherein the turning means (20) includes a plurality of gearboxes (23), a drive motor (21), and a drive shaft (22) which rotates by the drive motor (21), and
wherein the gearbox (23) includes a wheel gear (26) installed on the drive shaft (22), a worm gear (27) meshing with the wheel gear (26), and a worm shaft (28) fixing the worm gear (27) while rotating the slat block (33).

3. The louver apparatus according to claim 1, wherein the connector (32) is installed in the center of the slat block (33), and the expansion means is installed on each side of the connector (32).

4. The louver apparatus according to claim 1, wherein an impact-absorbing material (36) is installed at the side end of the slat block (33).

5. An envelope structure (100) of a building to which the louver apparatus (R) according to claim 1, comprising:
a support frame (110) installed on a structure of the building;
a guide frame (120) installed on the support frame (110) and protruding outside the building; and
an exterior enclosure (130) installed in the guide frame (120) in a drawer-like manner and containing the louver device (R).

6. The envelope structure according to claim 5, wherein the exterior enclosure (130) includes:
an exterior frame (131) having a glass panel (131a);
a fixed frame (132) located behind the exterior frame (131); and
a connection frame (133) connecting the exterior frame (131) and the fixed frame (132) and fixing the rail means (10) of the louver device (R).

7. The envelope structure according to claim 6, wherein an exterior strip (123) inclined downward outwardly is installed in front of the guide frame (120),
wherein an air circulation opening (123a) is formed between the exterior strip (123) and the exterior enclosure (130),
wherein an airflow meter (141) is installed inside the air circulation opening (123a),
wherein a solarimeter (142) is installed on the front of the exterior frame (131), and
wherein a surface temperature sensor (143) is installed on the fixed frame (132).

8. An envelope structure (100) of a building to which the louver apparatus (R) according to claim 2, comprising:
a support frame (110) installed on a structure of the building;
a guide frame (120) installed on the support frame (110) and protruding outside the building; and
an exterior enclosure (130) installed in the guide frame (120) in a drawer-like manner and containing the louver device (R).

9. An envelope structure (100) of a building to which the louver apparatus (R) according to claim 3, comprising:
a support frame (110) installed on a structure of the building;
a guide frame (120) installed on the support frame (110) and protruding outside the building; and
an exterior enclosure (130) installed in the guide frame (120) in a drawer-like manner and containing the louver device (R).

10. An envelope structure (100) of a building to which the louver apparatus (R) according to claim 4, comprising:
a support frame (110) installed on a structure of the building;
a guide frame (120) installed on the support frame (110) and protruding outside the building; and
an exterior enclosure (130) installed in the guide frame (120) in a drawer-like manner and containing the louver device (R).

11. The envelope structure according to claim 8, wherein the exterior enclosure (130) includes:
an exterior frame (131) having a glass panel (131a);
a fixed frame (132) located behind the exterior frame (131); and
a connection frame (133) connecting the exterior frame (131) and the fixed frame (132) and fixing the rail means (10) of the louver device (R).

12. The envelope structure according to claim 9, wherein the exterior enclosure (130) includes:
an exterior frame (131) having a glass panel (131a);
a fixed frame (132) located behind the exterior frame (131); and
a connection frame (133) connecting the exterior frame (131) and the fixed frame (132) and fixing the rail means (10) of the louver device (R).

13. The envelope structure according to claim 10, wherein the exterior enclosure (130) includes:
an exterior frame (131) having a glass panel (131a);
a fixed frame (132) located behind the exterior frame (131); and
a connection frame (133) connecting the exterior frame (131) and the fixed frame (132) and fixing the rail means (10) of the louver device (R).

14. The envelope structure according to claim 11, wherein an exterior strip (123) inclined downward outwardly is installed in front of the guide frame (120),
wherein an air circulation opening (123a) is formed between the exterior strip (123) and the exterior enclosure (130),
wherein an airflow meter (141) is installed inside the air circulation opening (123a),
wherein a solarimeter (142) is installed on the front of the exterior frame (131), and
wherein a surface temperature sensor (143) is installed on the fixed frame (132).

15. The envelope structure according to claim 12, wherein an exterior strip (123) inclined downward outwardly is installed in front of the guide frame (120),
wherein an air circulation opening (123a) is formed between the exterior strip (123) and the exterior enclosure (130),
wherein an airflow meter (141) is installed inside the air circulation opening (123a),
wherein a solarimeter (142) is installed on the front of the exterior frame (131), and
wherein a surface temperature sensor (143) is installed on the fixed frame (132).

16. The envelope structure according to claim 13, wherein an exterior strip (123) inclined downward outwardly is installed in front of the guide frame (120),
wherein an air circulation opening (123a) is formed between the exterior strip (123) and the exterior enclosure (130),
wherein an airflow meter (141) is installed inside the air circulation opening (123a),
wherein a solarimeter (142) is installed on the front of the exterior frame (131), and
wherein a surface temperature sensor (143) is installed on the fixed frame (132).
